(19) United States
(12) Patent Application Publication
(10) Pub. No.: US 2006/0054109 A1
(43) Pub. Date: Mar. 16, 2006

(54) Animal travel harness and restraint system

(76) Inventor: Joanne Joy Smith, Chelmsford (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/537,625

(22) PCT Filed: Dec. 8, 2003
(86) PCT No.: PCT/GB03/05344

§ 371 Date: Jun. 3, 2005

(30) Foreign Application Priority Data
Dec. 6, 2002 (GB) 0228494.1

(51) Int. Cl. A01K 27/00

(52) U.S. Cl. 119/856

(57) ABSTRACT

An animal restraint system (40) comprises an animal travel harness (10), having straps (11-16) adapted to fit around the neck (21) and upper body (25) of an animal (20) to be restrained; a generally circular belt (42), adapted to be secured to an upright portion (43) of a motor vehicle seat (44); and a pair of side linkages (41) for connecting the harness (10) to the belt (42). The harness (10) is provided with a pair of fixing points (27) at either side thereof, while the linkages (41) are provided at either end thereof with engagement clips (49) adapted to connect one end of each linkage (41) to one of the fixing points (27) on the harness (10), and the other end of each linkage (41) to a similar fixing point (47) on the belt (42).

This invention relates to an animal travel harness, and to an animal restraint system incorporating such a harness. In particular, it relates to a harness suitable both for use in securing a dog to a seat of a motor vehicle, and when exercising the dog on a lead.

The present invention has been developed for use with pet dogs, and will therefore be described herein with particular emphasis on this use. It is believed however, that the present invention will be equally effective for use with a wide range of different animals. Similarly, whilst the present invention has been developed particularly for use in securing a dog to a seat of a motor vehicle, it is envisaged that the invention may be adapted for securing or restraining animals in other situations, and may therefore find use in such areas as veterinary care, pet grooming salons etc.

It has for some time been appreciated that the transport of pet dogs in motor vehicles presents a number of potential hazards. The motion of an unrestrained dog within a vehicle can cause significant injuries both to itself, and to human occupants of the vehicle. This is of particular concern during harsh braking, cornering etc. when the dog may be flung about the inside of the car with some force.

To address the above issues, a variety of travel harnesses for dogs have been proposed over the years, often operating on the principle of providing means to adapt a standard car seat belt for the purpose of restraining a dog, e.g. by threading the seat belt through a part of the harness. However, such conventional dog travel harnesses have been found to be unsatisfactory for at least two reasons:

Firstly, the degree of restraint afforded to the dog by such systems is typically less than that afforded to a human occupant of a motor vehicle. That is to say, the dog is still flung around to some extent by the motion of the car. The danger posed to the dog and its human companions in the vehicle, is therefore only slightly reduced.

And secondly, many existing harnesses are designed to be secured to a seat of a motor vehicle at a single fixing point, usually located at or adjacent the dog's neck or spine. On harsh braking, this can cause whiplash or other non-impact injuries to the dog's neck or spine.

The present invention seeks to address the above-identified issues by providing an animal travel harness and restraint system, which enables a dog to be safely and securely restrained on a seat of a motor vehicle, whilst significantly reducing the risk of both impact and non-impact injuries to the dog.

According to a first major aspect of the present invention, there is provided an animal travel harness comprising:
a neck strap adapted to fit around the neck of an animal to be restrained;
a body strap adapted to fit around the body of said animal;
a chest strap, interconnecting the neck strap and the body strap, and adapted to embrace the chest of said animal; and
a spine strap, interconnecting the neck strap and the body strap, and adapted to extend along a portion of the spine of said animal;
and wherein:
the body strap is provided with two fixing points, arranged at either side thereof between the chest strap and the spine strap, each said fixing point being adapted to engage with one end of a linkage adapted at its other end for attachment to a motor vehicle seat; and
the spine strap is provided with a further fixing point adapted to engage with a standard animal exercise lead.

The neck strap and body strap are designed to extend circumferentially around a dog, either side of the dog's shoulders.

The neck strap and the body strap may each be formed as a generally circular, continuous loop. However, to enable the travel harness to be quickly and easily fitted to and removed from the dog, it is generally preferred that the neck strap has two free ends, each said end having complementary engagement means to enable the strap to be fastened around the dog's neck.

Similarly, the body strap may also be formed with two free ends, each said end having complementary engagement means to enable the body strap to be fastened around the dog's body. However, it is preferred that the body strap should instead comprise an upper half strap and a lower half strap, each said half strap having two free ends, each provided with complementary engagement means to enable engagement with the other half strap.

The upper half strap is thus attached to the spine strap only, and extends downwardly from the dogs shoulders, substantially half-way down each side of the dog's body. The equal length to which the upper half strap extends at either side of the dog's body ensures an equal restraining action, and spreading of any applied force. The lower half strap is attached to the chest strap only, and extends upwardly from the dog's underbelly at each side of the dog's body to meet and engage with the upper half strap. Each said half strap has two free ends, each provided with complementary engagement means to enable engagement with the other half strap.

The fixing points are preferably located at or adjacent the complementary engagement means on the body strap. Most preferably, each fixing point comprises a metal ring, whilst the complementary engagement means comprise a quick release clasp mechanism, such as inter-locking plastics buckles.

In order to accommodate dogs of differing sizes, the neck strap and/or the body strap are preferably adjustable. Most preferably, each strap of the harness is adjustable.

To provide additional support to the dog, the chest strap may desirably be expanded in a lateral direction, so as to spread any applied force over the dog's chest, and padded to enhance the dog's comfort.

According to a second major aspect of the present invention, there is further provided an animal restraint system comprising:
an animal travel harness as hereinbefore described;
a generally circular belt, adapted to be secured to an upright portion of a motor vehicle seat, by extending horizontally therearound, and comprising two forwardly-directed fixing points;
a pair of linkages, each adapted to engage at one end thereof with a fixing point on the body strap of the harness, and at the other end thereof with a fixing point on the belt.

Optionally, a third linkage may be provided, adapted to engage at one end thereof with the further fixing point on the spine strap of the harness, and at the other end thereof with a third fixing point on the belt.

Each belt fixing point preferably comprises a metal ring, whilst each linkage is preferably provided at either end thereof with a standard dog lead clip to enable connection of said end to its respective fixing point.

To enable the restraint system to be used with varying sizes of dog, each linkage is preferably adjustable. The circular belt may desirably also be adjustable, so as to enable its use on either a front or rear seat of a motor vehicle, as well as to permits its use in varying types and sizes of vehicles.

As an accessory to either of the aspects of the invention, a coat for the animal to be restrained may additionally be provided, said coat having apertures adapted to receive one or more straps of the harness.

In order that the present invention may be fully understood, preferred embodiments thereof will now be described in detail, though only by way of example, with reference to the accompanying drawings, in which:

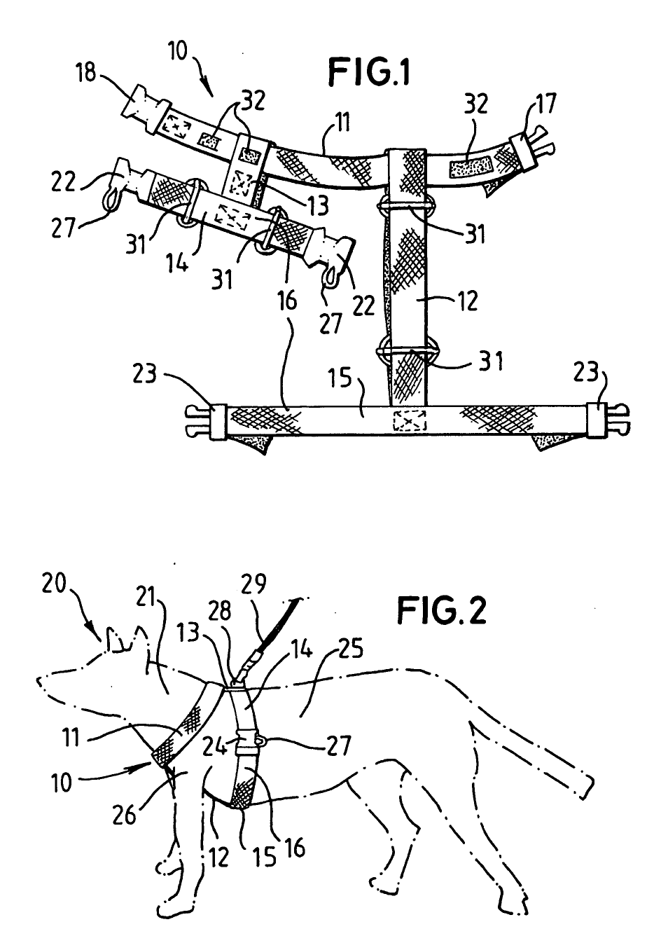

FIG. 1 shows an animal travel harness according to a first major aspect of the present invention, when laid out flat;

FIG. 2 shows a side view of a dog wearing the harness of FIG. 1 during on-lead exercise;

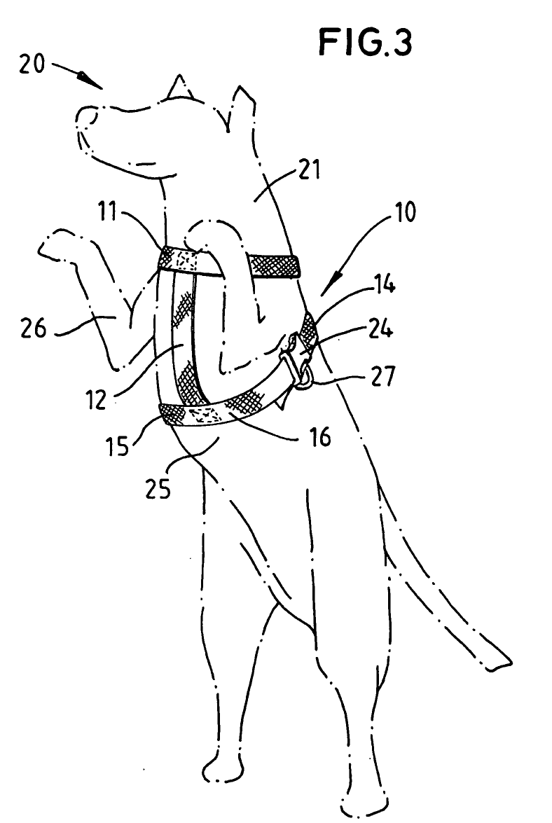

FIG. 3 shows a perspective view of the underside of the dog wearing the harness of FIG. 1;

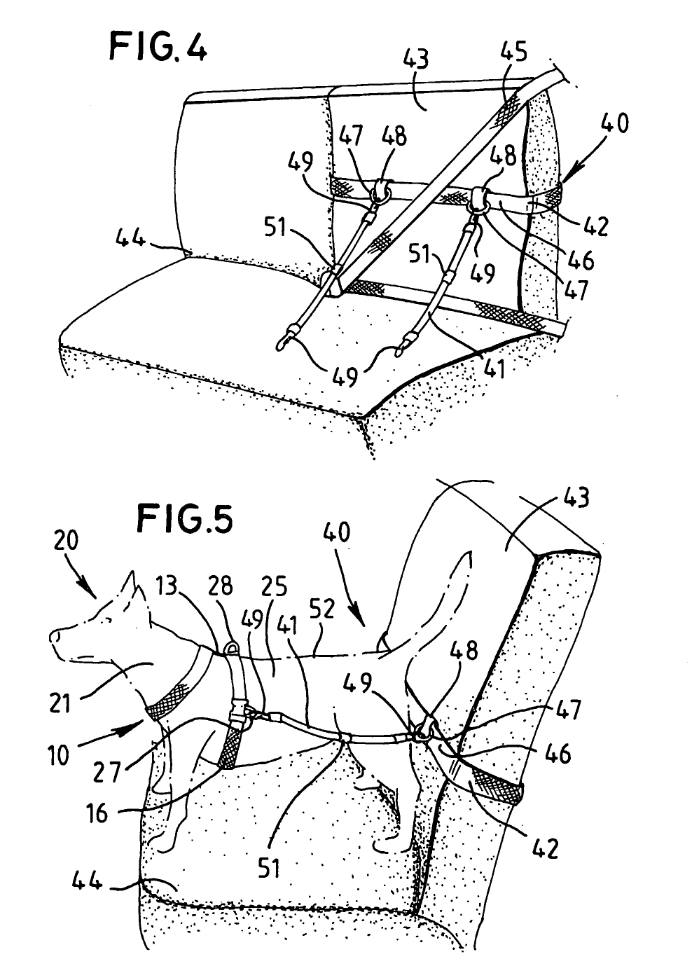

FIG. 4 shows part of an animal restraint system according to a second major aspect of the present invention;

FIG. 5 shows a side view of a dog, in a standing position, wearing the harness of FIG. 1 as part of the animal restraint system of FIG. 4;

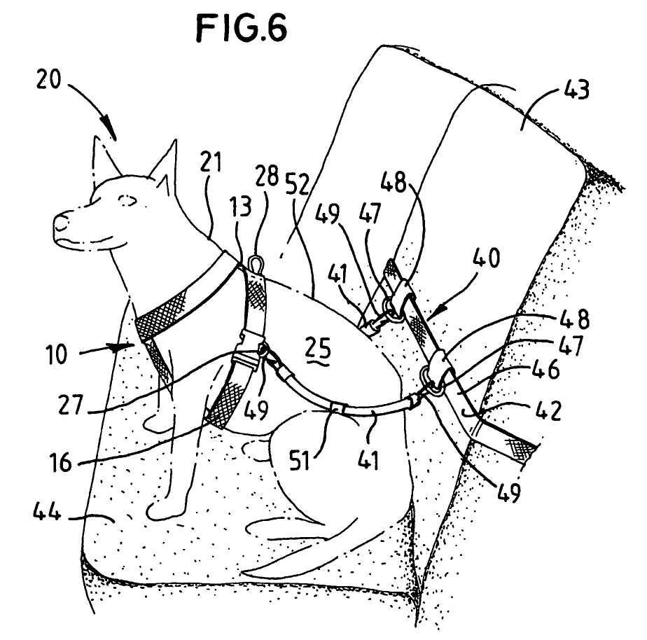

FIG. 6 shows a side view of the dog of FIG. 5, in a seated position;

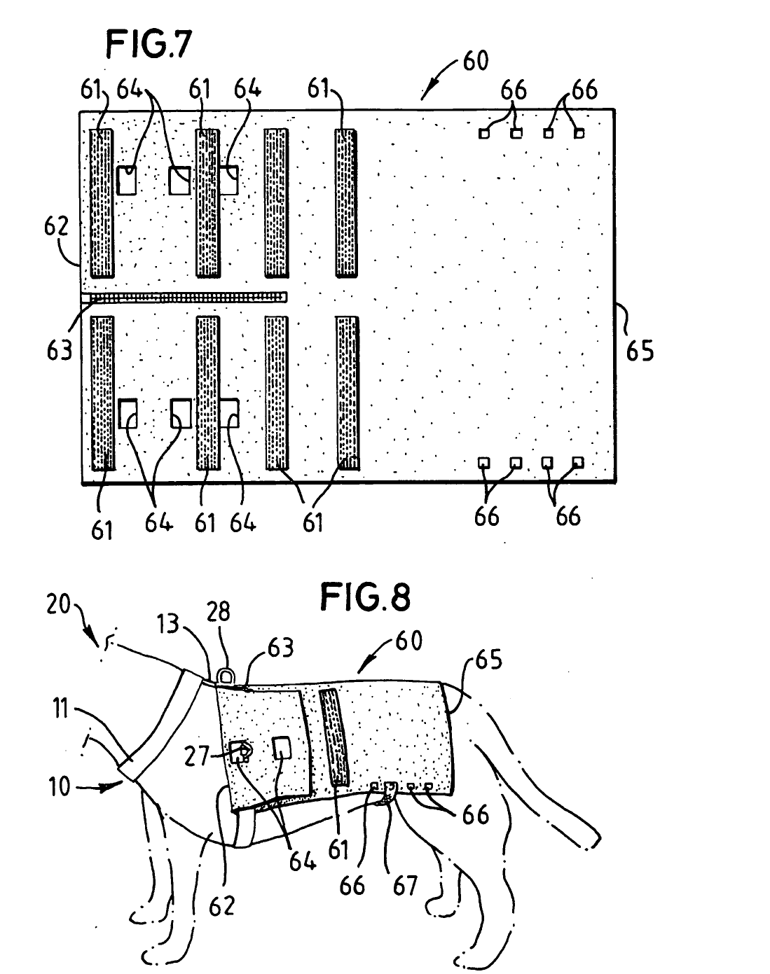

FIG. 7 shows a coat for an animal, forming an optional component of the travel harness of FIG. 1 or the animal restraint system of FIG. 4, when laid out flat; and

FIG. 8 shows a side view of a dog wearing the coat of FIG. 7 in combination with the harness of FIG. 1.

Referring first to FIGS. 1 to 3, there is shown an animal travel harness, generally indicated 10, according to a first major aspect of the present invention. The harness 10, which is shown in FIG. 1 opened up and laid flat, comprises a neck strap 11, a chest strap 12, a spine strap 13, and upper and lower half straps 14, 15 which together form a body strap 16.

The neck strap 11 is provided at one end thereof with a male connector 17, and at its other end with a complementary female connector 18. The male 17 and female connectors 18 together form a quick release clasp mechanism which in use enables the neck strap 11 to be secured in a loose-fitting arrangement, around the neck 21 of a dog, generally indicated 20, as is best shown in FIGS. 2 and 3.

The upper half strap 14 is provided at either end thereof with similar female connectors 22, whilst the lower half strap 15 is provided at either end thereof with similar male connectors 23. Each male connector 22 combines with its respective female connector 23, to form a similar quick release clasp mechanism 24. The upper and lower half straps 14, 15 may be combined using the clasp mechanism 24, around the body 25 of the dog 20, behind its front legs 26 to form the body strap 16. The body strap 16 embraces the body 25 of the dog 20 securely, but without being excessively tight.

The upper half strap 14 is additional provided with a pair of metal rings 27, located on the female connectors 22. These rings 27 act as fixing points to enable the harness 10 to be used as part of an animal restraint system, as will be discussed in more detail below, with reference to FIGS. 4 to 6. As is best shown in FIG. 2, the spine strap 13 is provided with a further ring 28, which acts as a fixing point for a standard dog lead 29.

Referring again to FIG. 1, each of the chest strap 12, and the upper half strap 14 are provided with buckles 31 to enable adjustment of their length. The size of the harness 10 may thus be varied so as to accommodate different sizes of dog 20. Each of the neck strap 11, spine strap 13, and lower half strap 15 may additionally also be provided with buckles 31.

Portions 32 of the neck strap 11 are also provided with fabric comprising a hook-and-loop closure system such as Velcro®, to enable the harness 10 to be attached to a dog coat, as will be discussed in more detail below with reference to FIGS. 7 and 8. Each of the chest strap 12, spine strap 13, and upper and lower half straps 14,15 may additionally also be provided with such portions 32.

Referring now to FIGS. 4 to 6, there is shown an animal restraint system, generally indicated 40, according to a second major aspect of the present invention (note: only part of the system is shown in FIG. 4). The system 40 comprises the animal travel harness 10, as described above with reference to FIGS. 1 to 3, a pair of side linkages 41, and a circular belt 42.

As is best shown in FIG. 4, the circular belt 42 is adapted to extend circumferentially around an upright portion 43 of a motor vehicle seat 44. The belt 42 is provided with adjustment means (not shown) to enable it to be used on either the front or rear seat 44 of a motor vehicle, and with seats 44 of differing sizes in different types of vehicles. Clearly, the larger the dog 20 to be restrained, the higher will be the required position on the upright portion 43. The belt 42 may optionally be further secured by fastening the motor vehicle's standard seat belt 45 over the top thereof.

The forwardly-directed face 46 of the belt 42 is provided with two metal rings 47 which act as fixing points for the side linkages 41. Each ring 47 is carried on a free-running nylon collar 48 mounted on the belt 42. Each linkage 41 is provided at either end thereof with a dog clip 49, by means of which one end of each linkage 41 attaches to the belt 42 via the rings 47, and the other end of each linkage 41 attaches to the harness 10 on the dog 20 via the rings 27 on the body strap 16. The linkages 41 are also provided with adjustment buckles 51 to enable the system 40 to be used with differing sizes of dog 20.

Although not shown in FIGS. 4 to 6, the restraint system 40 may additionally comprise a third linkage 41 having a dog clip 49 at one end thereof for attachment to the further ring 28 on the spine strip 13, and a like dog clip 49 at the other end thereof for attachment to a third fixing ring 47 carried on a third free-running collar 48 on the circular belt 42.

The dog 20 is thus secured to the seat 44, and may comfortably travel in either a standing position, as shown in FIG. 5, or a seated position, as shown in FIG. 6. However, any movement beyond the confines of the seat 44 is restricted, thus protecting the dog 20 and its human companions in the vehicle from impact injuries. The securing of the dog 20 in two positions 27 at the sides of its body 25 also serves to protect the dog 20 from non-impact injuries to its neck 21 and spine 52.

Referring now to FIGS. 7 and 8, there is shown a coat, generally indicated 60, for a dog 20, which coat 60 is an optional accessory to either of the first or second major aspects of the present invention, as described above with reference to FIGS. 1 to 6.

The coat 60 is provided with fabric strips 61 having a Velcro®-type hook-and-loop system, complementary to one another, and to the portions 32 on the harness 10. A plurality of strips 61 are provided to enable the neck end 62 of the coat 60 to be folded over, thereby permitting its use with differing sizes of dog 20. As shown in FIG. 8, the neck end 62 of the coat 60 may be adapted to fold over the body strap 16 of the harness 10. Alternatively, it may be folded over the neck strap 11 of the harness 10, again depending on the size of dog 20.

A zip 63 is provided adjacent the neck end 62 so as to enable the above-described folding, and also to permit access to the ring 28 on the spine strap 13. Apertures 64 are also provided in the coat 60 to permit access to the rings 27 on the body strap 16.

At the tail end 65 of the coat 60 are provided a plurality of studs 66. As shown in FIG. 8, an elasticated strap 67 is adapted to engage with the studs 66 at either end, and to embrace the dog's underbelly 68, therebetween.

1-16. (canceled)

17. An animal travel harness comprising:
a neck strap adapted to fit around an animal's neck;
a body strap adapted to fit around said animal's body and provided with two fixing points, each adapted for attachment to a motor vehicle seat by means of a pair of linkages, each said linkage having a first end adapted to engage with a said fixing point, and a second end adapted for attachment to said seat;
a chest strap, interconnecting said neck strap and said body strap, and adapted to embrace said animal's chest;
a spine strap, interconnecting said neck strap and said body strap, and adapted to extend along a portion of said animal's spine, said spine strap being provided with a further fixing point adapted to engage with a standard animal exercise lead;
and wherein said two fixing points are arranged at either side of said body strap between said chest strap and said spine strap.

18. The animal travel harness of claim 17, wherein the neck strap is formed as a generally circular, continuous loop.

19. The animal travel harness of claim 17, wherein the body strap is formed as a generally circular, continuous loop.

20. The animal travel harness of claim 17, wherein the neck strap and the body strap are each formed as a generally circular, continuous loop.

21. The animal travel harness of claim 17, wherein the neck strap has two free ends, each said end having complementary engagement means to enable said neck strap to be fastened around said animal's neck.

22. The animal travel harness of claim 17, wherein the body strap has two free ends, each said end having complementary engagement means to enable said body strap to be fastened around said animal's body.

23. The animal travel harness of claim 17, wherein the neck strap and the body strap each have two free ends, each said end having complementary engagement means to enable said neck strap to be fastened around said animal's neck, and to enable said body strap to be fastened around said animal's body.

24. The animal travel harness of claim 17, wherein the body strap comprises an upper half strap and a lower half strap, each said half strap having two free ends, each provided with complementary engagement means to enable engagement with said other half strap.

25. The animal travel harness of claim 24, wherein the upper half strap is attached to the spine strap only, and the lower half strap is attached to the chest strap only.

26. The animal travel harness of claim 22, wherein the fixing points are located adjacent the complementary engagement means on the body strap.

27. The animal travel harness of claim 21, wherein each complementary engagement means comprises a quick release clasp mechanism.

28. The animal travel harness of claim 17, wherein the neck strap and the body strap are adjustable, to accommodate animals of differing sizes.

29. The animal travel harness of claim 17, wherein each strap is adjustable, to accommodate animals of differing sizes.

30. The animal travel harness of claim 17, wherein the chest strap is expanded laterally and padded to provide additional support and comfort to said animal.

31. The animal travel harness as claimed in claim 17, wherein each fixing point comprises a metal ring.

32. An animal restraint system comprising:
the animal travel harness of claim 17;
a generally circular belt, adapted for securing to an upright portion of a motor vehicle seat, by extending horizontally around said seat, said belt comprising at least two forwardly-directed fixing points;
a pair of linkages, each said linkage having a first end adapted to engage with a fixing point on the body strap of said harness, and a second end adapted to engage with a fixing point on the belt.

33. The animal restraint system of claim 32, further comprising a third linkage having a first end adapted to engage with a further fixing point on the spine strap of said harness, and a second end adapted to engage with a third fixing point on the belt.

34. The animal restraint system of claim 32, wherein each belt fixing point comprises a metal ring, and each linkage is provided at each end thereof with a standard dog lead clip to enable connection of said end to its respective fixing point.

35. The animal restraint system of claim 32, wherein each linkage is adjustable to accommodate animals of differing sizes.

36. The animal restraint system of claim 32, further comprising a coat for said animal, said coat having apertures adapted to receive one or more straps of said harness.
